(19) United States
(12) Patent Application Publication
(10) Pub. No.: US 2014/0359489 A1
(43) Pub. Date: Dec. 4, 2014

(54) WEB BROWSER HISTORY

(71) Applicant: QUALCOMM Incorporated, San Diego, CA (US)

(72) Inventors: Colin Shengcai Zhao, Sunnyvale, CA (US); Itai Vonshak, Palo Alto, CA (US); Ian I. Tam, San Francisco, CA (US); Benjamin Andrew Rottler, San Francisco, CA (US)

(73) Assignee: QUALCOMM Incorporated, San Diego, CA (US)

(21) Appl. No.: 13/905,411

(22) Filed: May 30, 2013

(51) Int. Cl. G06F 3/0482

(52) U.S. Cl. CPC G06F 3/0482
USPC 715/760

(57) ABSTRACT

A web browser that records and displays browsing history. For each web page, a thumbnail image of the web page and a group associated with the web page are recorded. A group is displayed along a first axis, the thumbnail image of each page associated with that group displayable along a second orthogonal axis.

### BACKGROUND

The World Wide Web has become a ubiquitous part of business and personal activities. Many persons and entities around the world maintain a web sites. Each web site typically includes a set of web pages, often quite numerous, for that site. Web browsers that allow a user to access this wealth of web pages available on the web are implemented on a wide range of computers, appliances, and devices, including personal computers, laptop and notebook computers, tablet computers, and cellular phones. With the web browser users can navigate (i.e. “access”, “visit”, or “browse”) from one site or page to another. This can be done in a number of different ways, including specifying a universal resource indicator (“URI”) of a web page, or selecting a hyperlink (“link”) on one web page that causes the browser to navigate to another web page. The newly-accessed web page can replace the web page in a current window or tab of the browser, or can be opened in a new window or tab.

### BRIEF DESCRIPTION OF THE DRAWINGS

FIG. 1 is a schematic block diagram representation of an apparatus including a controller and a web browser in accordance with an example of the present disclosure.

FIG. 2 is a schematic block diagram representation of the controller of FIG. 1 in accordance with an example of the present disclosure.

FIG. 3 is a schematic representation of history data recorded by the controller of FIG. 1 or FIG. 2 in accordance with an example of the present disclosure.

FIG. 4 is a schematic representation of an example two-dimensional browsing history display having a single expanded group of thumbnail images in accordance with an example of the present disclosure.

FIG. 5 is a schematic representation of another example two-dimensional browsing history display having plural expanded groups of thumbnail images in accordance with an example of the present disclosure.

FIG. 6 is a schematic representation of the example browsing history display of FIG. 5 in which the browsing path to a selected web page is displayed in accordance with an example of the present disclosure.

FIG. 7 is a schematic representation of the example browsing history display of FIG. 6 in which the browsing path includes a collapsed group in accordance with an example of the present disclosure.

FIG. 8 is a schematic representation of the example browsing history display of FIG. 5 in which the thumbnail images are positioned along a timescaled axis according to the date and time that the web page corresponding to the thumbnail was browsed in accordance with an example of the present disclosure.

FIG. 9 is a schematic representation of the example browsing history display of FIG. 8 in which the browsing path to a selected web page is displayed in accordance with an example of the present disclosure.

FIG. 10 is a schematic representation of an example browsing history display where the browsing history for a group is displayed in a tree structure in accordance with an example of the present disclosure.

FIG. 11 is a schematic representation of another example browsing history display where the browsing history for a group is displayed in a tree structure in accordance with an example of the present disclosure.

FIG. 12 is a schematic representation of the example browsing history display of FIG. 10 or 11 in which the browsing path to a selected web page is displayed showing each browsing step in accordance with an example of the present disclosure.

FIG. 13 is a schematic representation of the example browsing history display of FIG. 10 or 11 in which the browsing path to a selected web page is displayed showing ancestor web pages in accordance with an example of the present disclosure.

FIG. 14 is a flowchart in accordance with an example of the present disclosure of the controller of FIG. 1 or 2, or a method implemented in the controller.

FIG. 15 is a lower-level flowchart in accordance with an example of the present disclosure of the display operations of FIG. 14.

### DETAILED DESCRIPTION

As noted in the Background section, web browsers can navigate or browse sequentially from web page to web page, within a single web site or across different web sites. A user may browse through a number of web sites before arriving at a particular one of interest. Sometimes this involves starting at a top-level (“root”) page of a site, and drilling down through multiple steps to reach a desired page at a lower level of the site. At other times it may involve navigating from web site to web site, for example via links on various web pages, in order to arrive at the desired web page. At some future time, the user may desire to reconstruct the sequence of browsing steps that led to a particular web page. Writing down each browsing step as it is taken is tedious and time-consuming, and few users would do this. The steps may be too complex to memorize, or may not be able to be recalled at a more distant future time.

Recognizing this, some browsers include a browsing history function that, upon invocation, shows a list of the web pages that were viewed by a user during different time periods. The browser typically records information about the web pages viewed by the user in a temporally-ordered linear list that specifies which web pages were opened or visited at what time. The list may be arranged, for example, by days or weeks. However, in many situations this capability may be deficient. For example, users frequently use multiple windows and/or tabs to access a number of web pages concurrently. However, such a browsing history function provides no way to organize how the user moves from web page to web page on a window or tab basis. This makes the path taken by the user to get to a particular web site difficult or impossible to reconstruct.

In other cases, forward and backward browsing buttons may be implemented by the browser. These buttons allow the user to move forward or backward in time from a given page. However, there is typically no time associated with or indicated by the forward or backward movement of these browsing buttons. Moreover, the context of the buttons is typically limited to the present browser window or tab with which the user is presently interacting. As such, it cannot account for cross-tab or cross-window navigation sequences performed by the user.

Referring now to the drawings, there are illustrated examples of an apparatus, method, and computer-readable storage medium constructed in accordance with the present disclosure that relate to a browsing history for a web browser. As each web site is browsed by the browser, history information including a thumbnail image of the web site and a group associated with the web site is recorded. Upon a user request to view the browsing history, the history information is subsequently displayed in two-dimensional form with groups arranged along one axis and the thumbnails associated with each group arranged along an orthogonal axis.

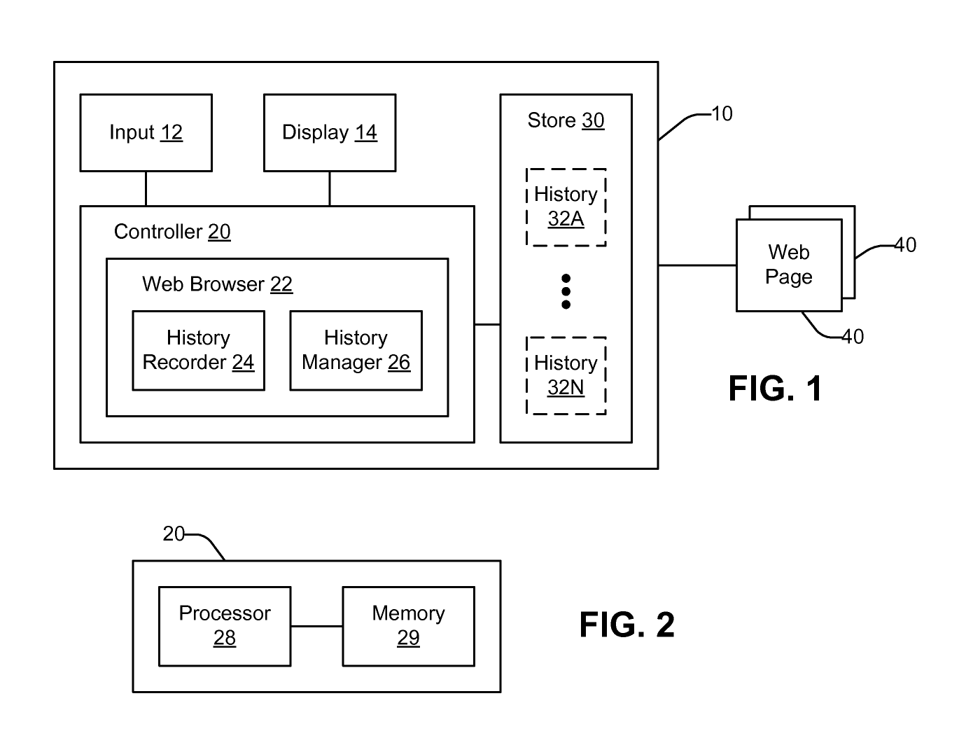

Considering now an apparatus that includes a web browser, and with reference to FIG. 1, an apparatus 10 includes a controller 20 that includes a web browser 22. The web browser 22 includes a history recorder 24 that is structured to save in a data store 30, for each of a sequence of web pages 40 browsed by the browser, history data (history information) 32 including a thumbnail image of the page and a group with which the page is associated. The web browser 22 also includes a history manager 26 that is structured to, in response to an input 12 received by the controller 20, process the saved history data 32 so as to display on a display unit 14 at least one group along a first axis, and the thumbnail image of each web page 40 that is associated with that group along a second axis orthogonal to the first axis. While the display unit 14 is illustrated as part of the apparatus 10, in another example the display may be external to, and communicatively coupled to, the apparatus 10.

In some examples, the controller 20 is further structured to also receive, via the input 12, a selection of the thumbnail image of one of the displayed web pages 40. The history manager 26 is further structured to, in response to this selection, display a browsing path leading to the selected web page 40. The browsing path highlights the sequence of web pages 40 that were traversed by the web browser 22 in order to arrive at the selected web page 40.

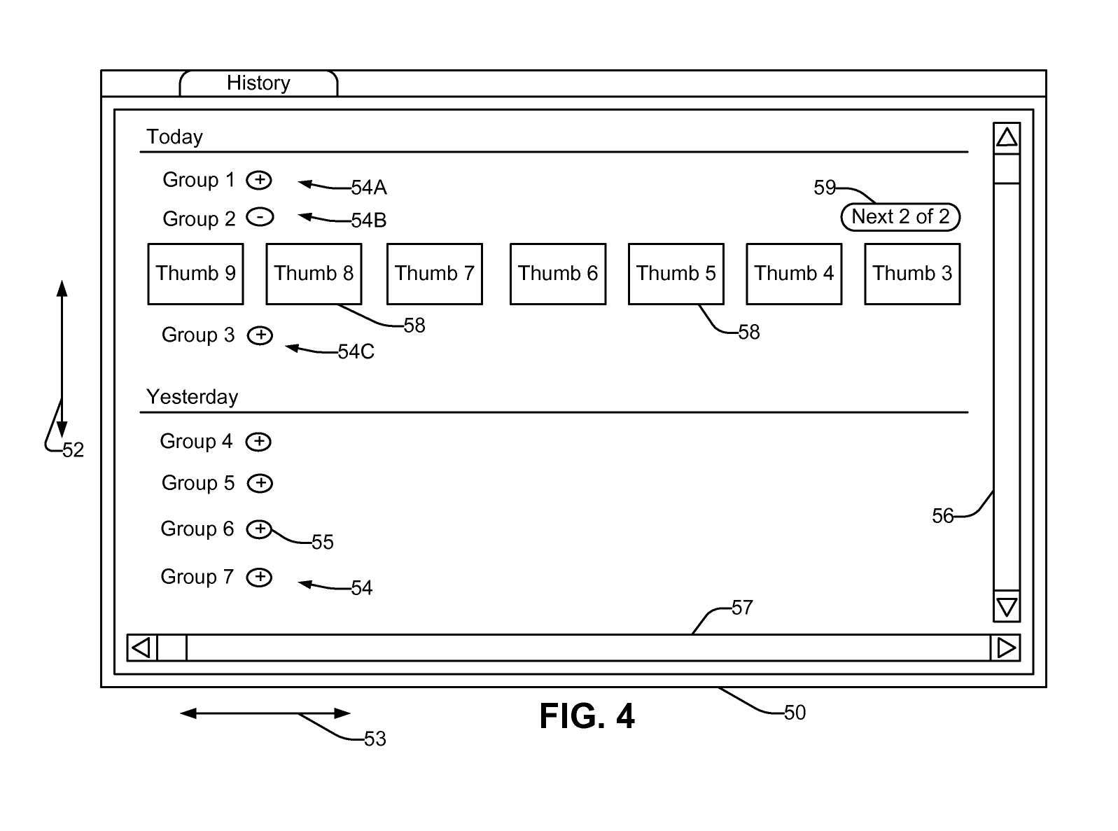

The display that the history manager 26 produces on the display 14, including the axes, groups, thumbnails, and browsing paths, are described subsequently in greater detail with reference to FIGS. 4-12.

The controller 20 may be implemented in hardware, in firmware, in software, or in a combination of these. In some examples, as can be appreciated with reference to FIG. 2, the controller 20 may include a processor 28 that is communicatively coupled to a computer-readable storage medium such as a memory 29. The memory 29 may have stored thereon one or more executable programs of instructions that, when executed by the processor 28, performs at least some of the operations of the controller 20, the history recorder 24, and/or the history manager 26.

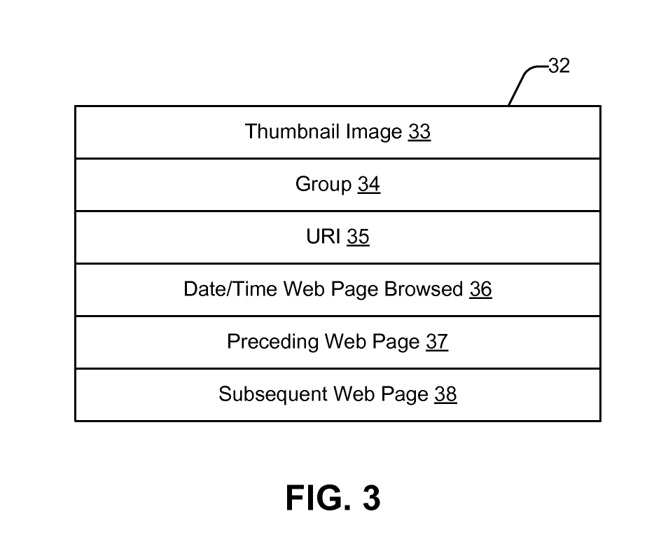

Considering now in greater detail the history data 32 saved in the data store 30 for a browsed web page 40, and with reference to FIG. 3, the history data 32 includes a thumbnail image 33 for the browsed web page 40 and a group 34 with which the web page 40 is associated. In some examples, the history data 32 further includes a universal resource indicator (“URI”) 35 of the browsed web page 40; a date and time 36 at which the browsing of the web page 40 occurred; a preceding web page 37 browsed or accessed by the web browser 22 immediately prior to the web page 40 that corresponds to the history data 32; and a subsequent web page 38 browsed or accessed by the web browser 22 immediately after to the web page 40 that corresponds to the history data 32. Where the history data 32 corresponds to the most recently browsed web page, the subsequent web page 40 may be null. In the data store 30, each history data element 32 may be a data structure having the individual fields 34-38. The preceding web page 37 and subsequent web page 38 fields may be pointers to other history data elements 32 which correspond to the preceding web page 37 and subsequent web page 38. As such, the set of history elements 32 may constitute a doubly-linked list of data structures.

Considering now a first example two-dimensional browsing history display 50, and with reference to FIG. 4, groups 54 of browsed web pages are arranged along a first axis 52. Seven example groups (Group 1 through Group 7) are depicted, with the first three of the groups 54 denoted as groups 54A-C. In some examples, each group corresponds to a different window of the web browser 22, or a different tab of the web browser 22. All of the browsed web pages associated with a particular group were browsed to from the corresponding browser window or browser tab.

In some examples, each group 54 corresponds to a different top-level domain of the URIs of the browsed web pages; or in other words, to different web sites. For example, Group 1 may correspond to web pages which have the top-level domain of “site1.com”, such as the web pages “www.site1.com/page1” and “www.site1.com/page2”.

The groups 54 are typically arranged along the first axis 52 in a descending time order from top to bottom. In some examples, the time order of the groups is determined by the date and time of access of the most recently accessed web page associated with each group. For example, the most recently-accessed web page associated with Group 1 54A was accessed more recently than any web page associated with Group 2 54B; the most recently-accessed web page associated with Group 2 54B was accessed more recently than any web page associated with Group 3 54C; and so on through the rest of the groups. In some examples, where each group represents a browser window or tab, all currently-open windows or tabs may be arranged along the first axis 52 before any closed (i.e. no longer open) windows or tabs.

In some examples, a timescale may be indicated for the first axis 52. In some examples, the timescale may be the insertion of a time-and-date separator, such as “Today”, “Yesterday”, “2 Days Ago”, and so on. The separator may be more granular (e.g. by week, month, year, etc.) or less granular (e.g. by hour, minute, etc.).

In some other examples, the groups 54 may be arranged along the first axis 52 in other than time order; for example, alphabetically by group name, or according to some other scheme.

In many cases there will be more groups than can be displayed at one time, and so a scroll/slider bar 56 or some analogous mechanism may be used to scroll or page groups up and down.

Each group includes an expand/collapse button 55. The button can assume two states. In the collapsed state, indicated by a “+” sign in the button 55, the browsed web pages associated with the group are not shown.

The “+” sign indicates that the group can be expanded by selecting the button 55. The expanded state is indicated by a “−” sign in the button 55. The “−” sign indicates that the group can be collapsed by selecting the button 55.

In the expanded state, the browsed web pages associated with the group are shown. For example, the button 55 for Group 2 has a “−” sign, and the thumbnail images 58 of seven browsed web pages that are associated with Group 2 are illustrated. The thumbnail images 58 are arranged along a second axis 53 that is orthogonal to the first axis 52.

Each thumbnail image is a smaller depiction of the browsed web page. Typically a bitmap of the web page is taken and recorded as the thumbnail image 34 of the history data 32. In some examples, the screenshot may be image-processed appropriately to reduce it to a smaller size for storage.

The thumbnail images 58 are typically arranged along the second axis 53 in descending time order from left to right. In some examples, the time order of the images may be determined by the date and time of access of the various web pages that are associated with that particular group. For example, the web page corresponding to Thumb 9 was accessed more recently than the web page corresponding to Thumb 8; the web page corresponding to Thumb 8 was accessed more recently than the web page corresponding to Thumb 7; and so on through the rest of the thumbnail images 58.

In many cases there will be more thumbnail images 58 associated with a group than can be displayed at one time, and so a scroll/slider bar 57 or some analogous mechanism may be used to scroll or page the thumbnail images 58 left and right for all of the groups that are presently displayed.

Alternatively or in addition, a “Next N of M” button 59 may be associated with each expanded group where applicable. The value M of the button 59 indicates the number of remaining thumbnail images 58 that are associated with the group, while the value N indicates the number of those remaining thumbnail images 58 that will be displayed if the button 59 is selected.

Although not illustrated, it can be appreciated that a “Prey N of M” button may also be displayed in place of, or in addition to, the “Next N of M” button as is appropriate based on the number of web pages associated with the group and the number of thumbnail images 58 that are presently displayed. For example, assume that when the button 59 is selected, the set of thumbnail images 58 displayed represent Thumb 7 through Thumb 1. In this case, there would be no “Next N of M” button, but a “Prey 2 of 2” button would be shown so that the user could once again use it to view Thumb 9 and Thumb 8. Each expanded group may have “Next N of M” and “Prey N of M” buttons that operate independently of one another. In other words, the thumbnail images 58 that get displayed for each group at one time can be determined independently of the other groups.

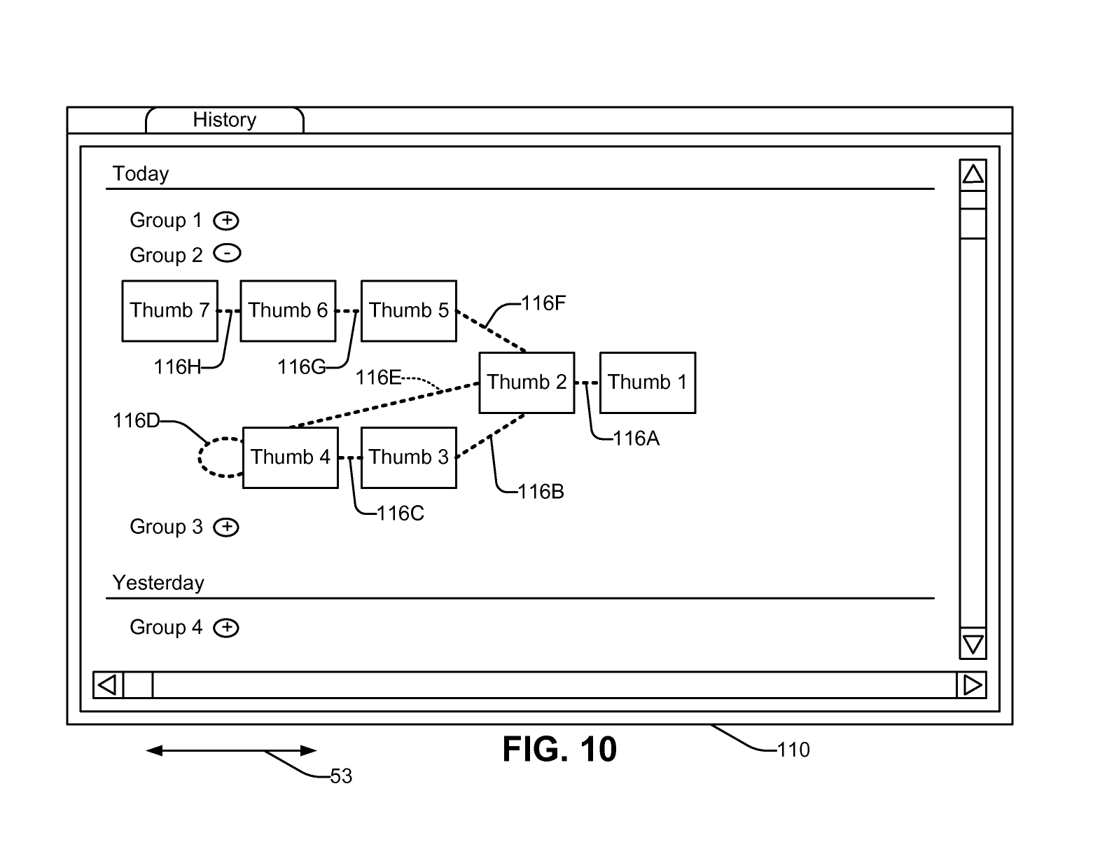

In the example display of FIG. 4, the thumbnail images 58 for each group are displayed linearly. In addition, each visit to a web page is given its own thumbnail image, even if the web page was previously visited. For example, assume that the user browses from web page A to web page B, and then back to web page A. If Thumb 5 corresponded to the first access of web page A, then Thumb 6 corresponds to the access of web page B, and Thumb 7 corresponds to the second access of web page A. As will be discussed subsequently with reference to FIGS. 10-13, the thumbnail images 58 for each group may alternatively be displayed in a tree structure.

In the example display of FIG. 4, the second axis 53 has no timescale; the thumbnail images 58 are spaced at a regular interval from left to right. Thus the positioning on the display of the thumbnail images 58 provide no information about the date and time when the web page corresponding to the particular thumbnail image 58 was browsed to. In some examples, a date and time stamp (not shown) may be displayed adjacent to each thumbnail image 58 to indicate the time of browsing.

While the thumbnail images 58 have been illustrated at a particular size, in some examples zoom controls (not shown) may be used to control the displayed thumbnail size. This allows more thumbnails of a smaller size, or fewer thumbnails of a larger size, to be displayed. The zoom controls may also have a corresponding effect on the number of groups that get displayed at any time as the amount of space along the first axis 52 used for displaying the thumbnail images expands or shrinks.

In addition, while the groups have been arranged along the first axis 52 and the thumbnail images 58 along the second axis 53, this placement can be swapped in other examples.

A web page 40 shown as a thumbnail image 58 in the browsing history display can be accessed or browsed-to by selecting the thumbnail image 58, such as for example by double-clicking the thumbnail image 58. The browsing history display will be exited, and the web page 40 accessed by the web browser 22 in the normal fashion.

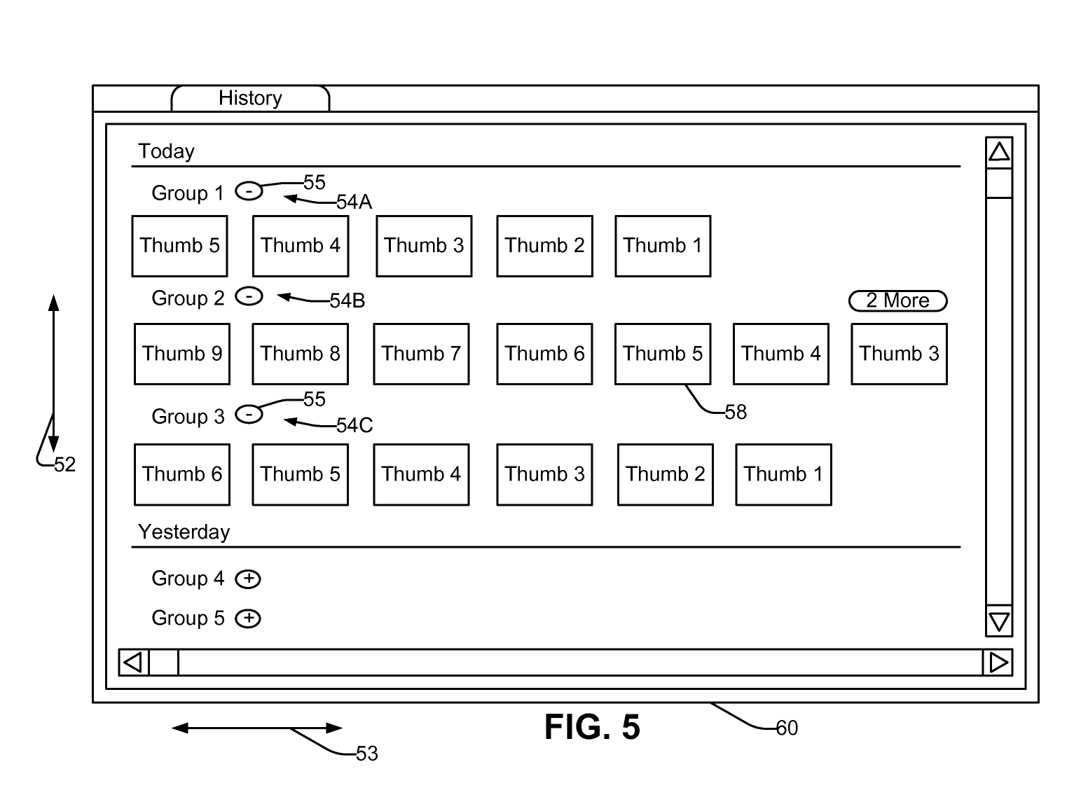

Considering now the expansion of additional groups of the browsing history display 50 of FIG. 4, and with reference to FIG. 5, in a browsing history display 60 thumbnail images 58 are displayed for Group 1 54A and Group 3 54C, in addition to Group 2 54B. The expand/collapse buttons 55 for Groups 1 and 3 illustrated the expanded state of Groups 1 and 3 as indicated by the “−” sign in the buttons 55.

For any individual group 54, the ordering of the thumbnail images 58 along the second axis 53 indicates the time order in which the web pages 40 corresponding to the thumbnail images 58 were browsed to. However, the browsing history display 60 does not identify the browsing path by which a particular web page 40 was accessed. Where a group corresponds to a web site (e.g. a top-level domain), the browsing path typically crosses different groups frequently. Where a group corresponds to a browser window or tab, the browsing path may cross groups where a link selected in one window is opened in another window.

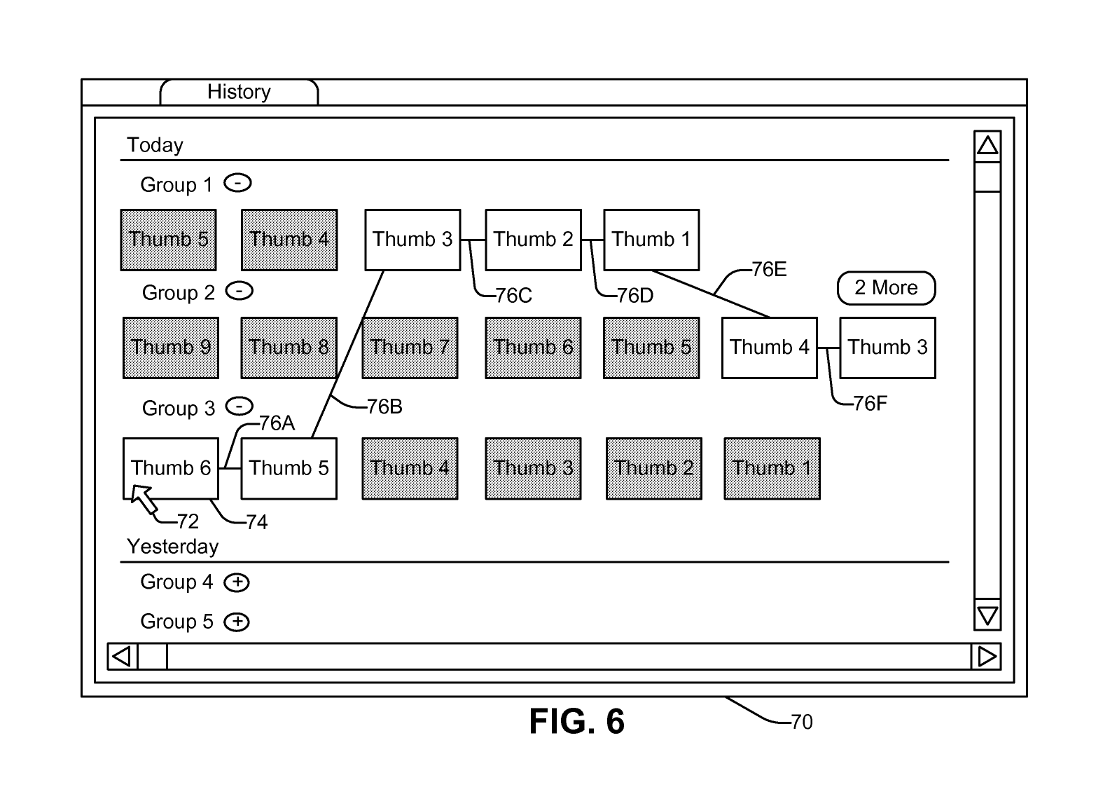

Considering now an example two-dimensional browsing history display 70 in which the browsing path to a selected web page is shown, and with reference to FIG. 6, a cursor 72 points to the thumbnail image Thumb 6 74, which corresponds to the web page to be selected. In some examples, the web page for which the browsing path is to be displayed is selected by pointing the cursor 72 to, or hovering the cursor 72 over, the thumbnail image corresponding to the web page to be selected.

When the thumbnail image 74 corresponding to the web page is selected, a path 76 having segments 76A-F is displayed. The path 76 visually depicts to the user the browsing path which led to the web page that corresponds to thumbnail image 74. Segment 76A illustrates that the web page that corresponds to thumbnail image Thumb 6 of Group 3 was browsed to from the web page that corresponds to thumbnail image Thumb 5 of Group 3. Segment 76B illustrates that the web page that corresponds to thumbnail image Thumb 5 of Group 3 was browsed to from the web page that corresponds to thumbnail image Thumb 3 of Group 1. Segment 76C illustrates that the web page that corresponds to thumbnail image Thumb 3 of Group 1 was browsed to from the web page that corresponds to thumbnail image Thumb 2 of Group 1. Segment 76D illustrates that the web page that corresponds to thumbnail image Thumb 2 of Group 1 was browsed to from the web page that corresponds to thumbnail image Thumb 1 of Group 1. Segment 76E illustrates that the web page that corresponds to thumbnail image Thumb 1 of Group 1 was browsed to from the web page that corresponds to thumbnail image Thumb 4 of Group 2. Segment 76F illustrates that the web page that corresponds to thumbnail image Thumb 4 of Group 2 was browsed to from the web page that corresponds to thumbnail image Thumb 3 of Group 2.

By displaying the browsing path taken to arrive at a selected web page, the relationships between the groups can be understood. For example, assume that each group corresponds to a different browser window or tab. In this situation, it is readily apparent from path segment 76E that a link in the web page corresponding to Thumb 4 of Group 2 was selected by the user and opened in the new tab or window of Group 1. As another example, assume that each group corresponds to a different web site (i.e. a different top-level domain). In this situation, it is readily apparent from path segment 76E that, from the web page corresponding to Thumb 4 of the web site corresponding to Group 2, the user navigated to a different web site (i.e. a different top-level domain) that corresponds to Group 1. For example, from the web page “http://www.site2.com/page4.html” of Group 2 Thumb 4, the user navigated to “http://www.site1.com/page1.html” of Group 1 Thumb 1.

In some examples, when a web page for which the browsing path is to be displayed is selected, those thumbnail images corresponding to those web pages that were not in the browsing path leading to the selected web page are omitted from the path 76. The omission may be depicted by thumbnail images which are not connected to any path segment. The omission may alternatively or additionally be depicted by the thumbnail images being visually deemphasized relative to thumbnail images that are included in the browsing path. The visual deemphasis may be illustrated by graying the thumbnails out, by fading the thumbnails, or in other ways.

In some situations, the browsing path may include web pages of groups which are presently displayed in the collapsed state. In some examples, selection of a browsing path may automatically change the state of such groups to the expanded state so as to show web pages of those groups. As defined herein and in the appended claims, the terms “automated” or “automatically” (and like variations thereof) shall be broadly understood to mean controlled operation of an apparatus, system, and/or process using computers and/or mechanical/electrical devices without the necessity of human intervention, observation, effort and/or decision.

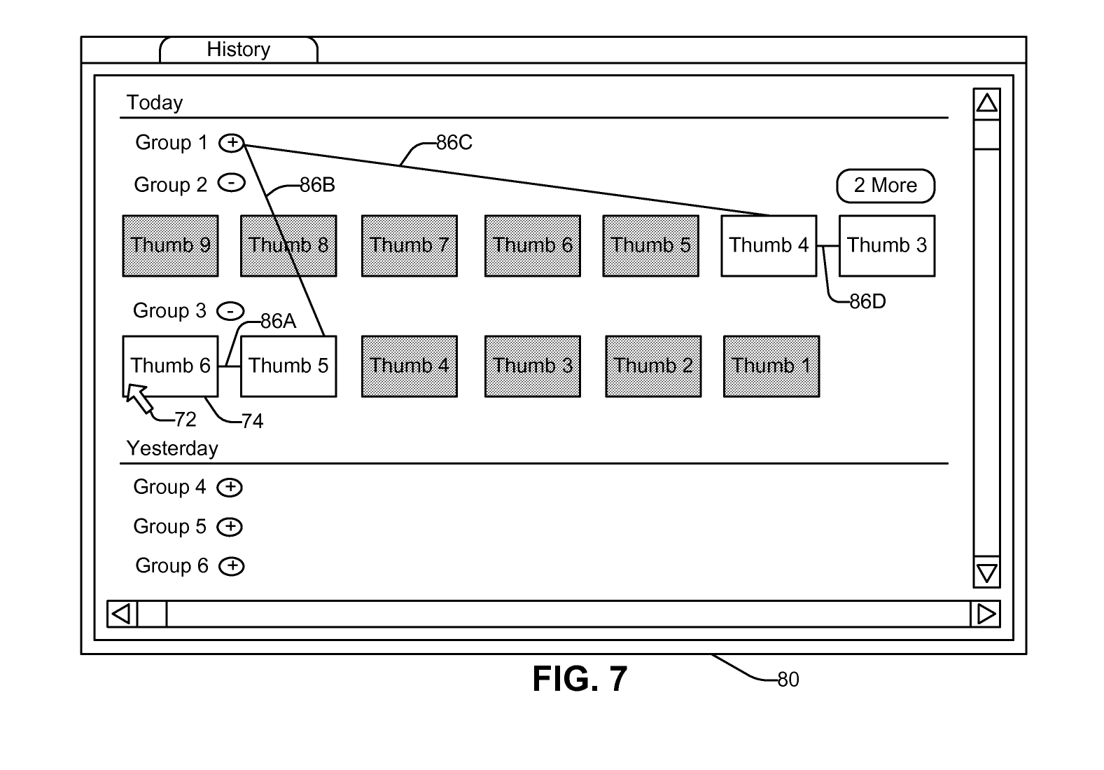

In other examples, one or more segments of the browsing path may connect to the collapsed group. This can be appreciated with reference to FIG. 7, where the browsing history display 80 is the same as the browsing history 70 of FIG. 6, except that Group 1 in the browsing history display 80 is in the collapsed state, not the expanded state. Group 3 Thumb 5 was browsed to from Group 1 Thumb 3. However, because Group 1 is in the collapsed state, path segment 86B connects Group 3 Thumb 5 to Group 1. Similarly, Group 1 Thumb 1 was browsed to from Group 2 Thumb 4, and so path segment 86C connects Group 1 to Group 2, Thumb 4. Path segment 86A corresponds to path segment 76A, and path segment 86D corresponds to path segment 76F.

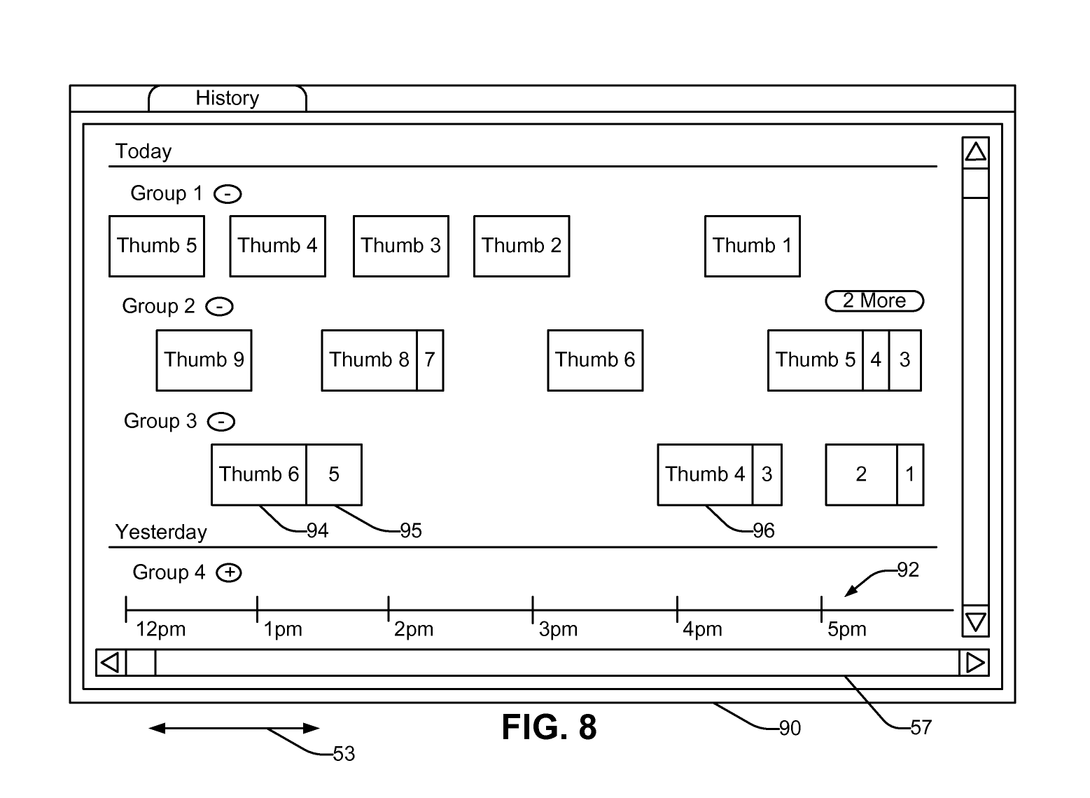

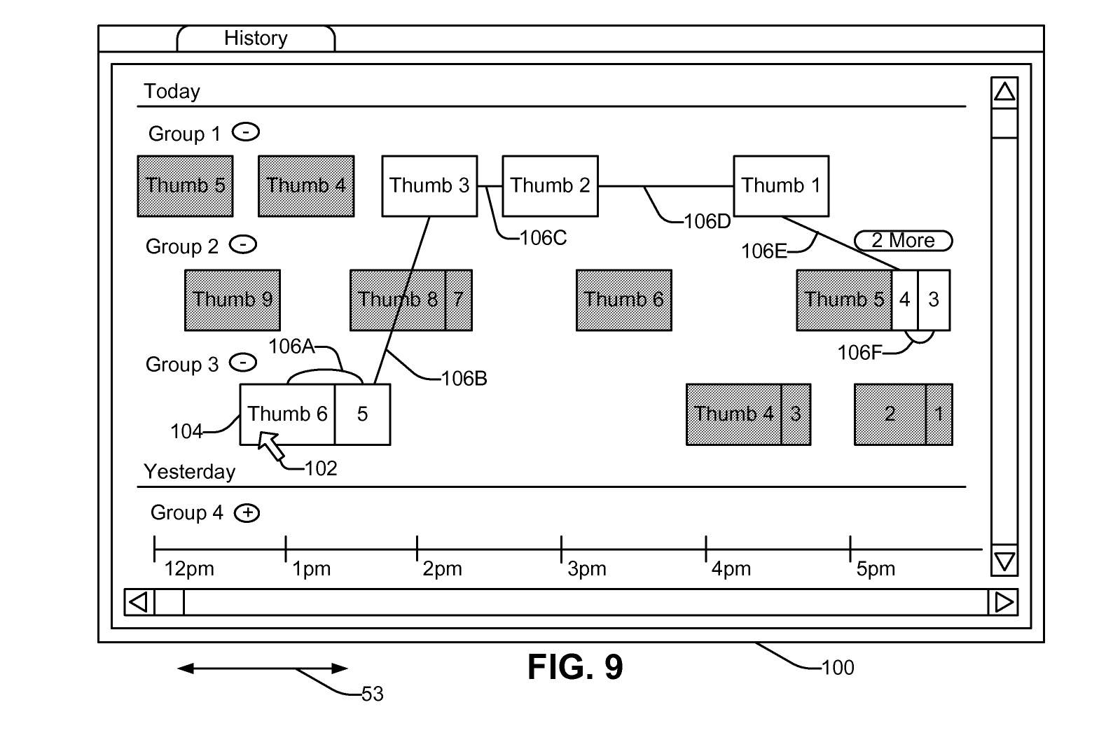

FIGS. 4-7 illustrate a browsing history display having a second axis 53 that has no timescale associated with it, or with the placement of thumbnail images 58 along the second axis 53. However, in some examples the second access may include a timescale. In such examples, and with reference to FIG. 8, the thumbnail images 58 are disposed along the second axis 53 at a position where the date and time that the web page 40 corresponding to the thumbnail 58 was browsed is aligned with the date and time of the second axis 53.

In addition to the scroll/slider bar 57 for the second axis 53, the browsing history display 90 includes a timescale 92. The timescale 92 typically displays the date and/or time. Typically the timescale 92 can be zoomed in or out as desired. When the timescale 92 is zoomed, the placement of the various thumbnail image 58 along the second axis 53 is changed proportionally to the amount of the zooming, in order to keep the thumbnail images 58 disposed at the corresponding date and time. In some examples, the size of the thumbnail images 58 is not affected by the zooming, while in other examples the size of the thumbnail images 58 may also be scaled proportionally to the amount of the zooming.

In order to place the thumbnail images 58 at the appropriate date and time position along the second axis 53, the spacing between adjacent thumbnail images 58 for a group is variable, and can be different between different images 58 for a group. Furthermore, thumbnail images 58 may be overlaid or cascaded as appropriate in order to position each of them at the proper date and time. For example, the set of thumbnail images 58 displayed in the browsing history display 90 of FIG. 8 is the same set of thumbnail images 58 as displayed in the browsing history display 60 of FIG. 5. It can be appreciated that, in the browsing history display 90 of FIG. 8, and for the selected timescale 92, the web page 40 that corresponds to Thumb 6 94 was browsed some fraction of an hour after the web page 40 that corresponds to Thumb 5 95, while the web page 40 that corresponds to Thumb 5 95 was browsed over 2 hours after the web page 40 that corresponds to Thumb 4 96. In this way the browsing history display 90 provides the user at a glance with a time context for the browsing history.

The timescale 92 applies to the thumbnail images of all of the groups. As a result, two thumbnail images that are vertically aligned with each other were browsed to at the same time.

The browsing path to a particular web page can be shown, for a browsing history display having a timescaled second axis as in FIG. 8, in a similar manner as illustrated in FIG. 6 for a browsing history display having an unscaled second axis. Considering now a browsing history display 100 having a timescaled second axis, and with reference to FIG. 10, a cursor 102 points to the thumbnail image Thumb 6 104, which corresponds to the web page to be selected. When the thumbnail image 104 is selected, a path 106 having segments 106A-F is displayed. The path 106 visually depicts to the user the browsing path which led to the web page that corresponds to thumbnail image 104. Segment 106A illustrates that the web page that corresponds to thumbnail image Thumb 6 of Group 3 was browsed to from the web page that corresponds to thumbnail image Thumb 5 of Group 3. Segment 1068 illustrates that the web page that corresponds to thumbnail image Thumb 5 of Group 3 was browsed to from the web page that corresponds to thumbnail image Thumb 3 of Group 1. Segment 106C illustrates that the web page that corresponds to thumbnail image Thumb 3 of Group 1 was browsed to from the web page that corresponds to thumbnail image Thumb 2 of Group 1. Segment 106D illustrates that the web page that corresponds to thumbnail image Thumb 2 of Group 1 was browsed to from the web page that corresponds to thumbnail image Thumb 1 of Group 1. Segment 106E illustrates that the web page that corresponds to thumbnail image Thumb 1 of Group 1 was browsed to from the web page that corresponds to thumbnail image Thumb 4 of Group 2. Segment 106F illustrates that the web page that corresponds to thumbnail image Thumb 4 of Group 2 was browsed to from the web page that corresponds to thumbnail image Thumb 3 of Group 2.

By displaying the browsing path taken to arrive at a selected web page, the relationships between the groups can be understood in a similar way as has been described heretofore with reference to FIG. 6. In addition, those thumbnail images corresponding to those web pages that were not in the browsing path leading to the selected web page are omitted from the path 106 and may alternatively or additionally be depicted by thumbnail images that are visually deemphasized relative to thumbnail images that are included in the browsing path. Furthermore, if the browsing path 106 includes web pages associated with groups which are presently displayed in the collapsed state, selection of the browsing path 106 may automatically change the state of such groups to the expanded state so as to show web pages of those groups, or segments of the browsing path 106 may connect to the collapsed group in an analogous way as has been described heretofore with reference to FIG. 7.

In FIGS. 4-9, the thumbnail images 58 for each individual group are arranged in a linear manner for that group. In addition, each time a particular web page is browsed to, an additional thumbnail image will be displayed for that web page in the browser history display. Considering now another example browsing history display, and with reference to FIG. 10, a browsing history display 110 can be arranged in a tree structure for each group, rather than in a linear manner. For a tree structured browsing history display, additional browsings to a previously-browsed web page does not cause an additional thumbnail image to be displayed. Rather, one thumbnail for that web page is displayed regardless of the number of times that page is browsed to. A branch is displayed from the thumbnail image of that web page for each different web page that is browsed to from that web page. Thus the display of the thumbnail images for a single group can be two-dimensional rather than linear.

In FIG. 10, Group 2 is illustrated in the expanded state, and uses a tree structure to display the browsing history for the group. The dashed lines 116A-H explain the sequence in which the web pages corresponding to the thumbnail images have been browsed. Starting from Thumb 1, the first-browsed web page in the group, line 116A indicates that the web page corresponding to Thumb 2 was browsed next. Line 1168 indicates that the web page corresponding to Thumb 2 was browsed from the web page corresponding to Thumb 1. Line 116C indicates that the web page corresponding to Thumb 3 was browsed from the web page corresponding to Thumb 2. Line 116C indicates that the web page corresponding to Thumb 4 was browsed from the web page corresponding to Thumb 3.

In some situations, data can be entered by the into an input element of the web page, or a selection of radio and/or check buttons on the web page corresponding to Thumb 4 can made, after which the same web page is redisplayed to show the effect of such inputs. Line 116D illustrates this situation. Some web browsers may detect this situation, while others may not.

Line 116E indicates that the web page corresponding to Thumb 2 was browsed from the web page corresponding to Thumb 4. This is the second browsing to the web page corresponding to Thumb 2 in the browsing history for Group 2. However, unlike in the linear thumbnail arrangement of FIGS. 4-9, the second browsing event does not cause a separate second thumbnail image for this web page to be displayed in the tree structured browsing history display 110.

Line 116F indicates that the web page corresponding to Thumb 5 was browsed from the web page corresponding to Thumb 2. Since this is a different browsing path taken from the web page corresponding to Thumb 2 than was taken previously, another branch from Thumb 2 is generated.

Line 116G indicates that the web page corresponding to Thumb 6 was browsed from the web page corresponding to Thumb 5, and line 116H indicates that the web page corresponding to Thumb 7 (i.e. the most recently-browsed web page in Group 2) was browsed from the web page corresponding to Thumb 6.

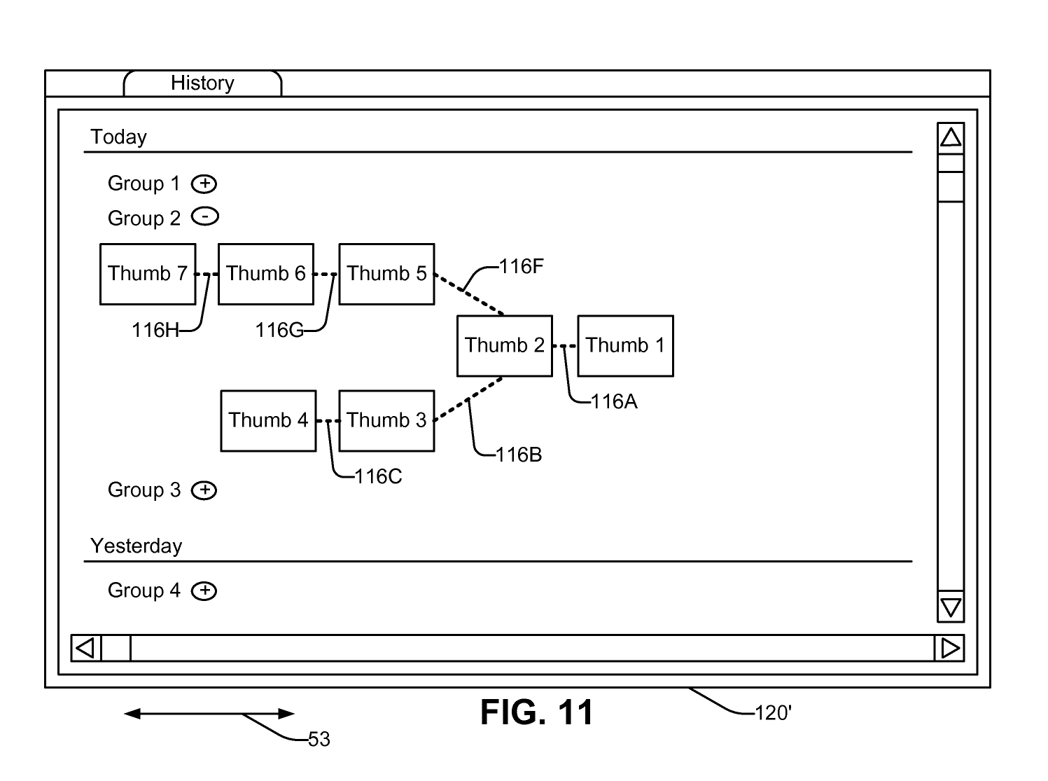

In various examples, some or all the dashed lines 116A-H may or may not be displayed in the situation where no thumbnail image is selected to show the browsing path. In some, all the dashed lines 116A-H may be omitted. In others, the dashed lines 116A-H may be displayed. In still others, as can be appreciated with reference to FIG. 11, a browsing history 120′ includes a modified set of dashed lines that shows the first browsing path to a given web page but not other paths; i.e. lines 116D-E are omitted. Thus browsing history display 120′ has a more classical tree structure, in which each thumbnail node has at most a single “ancestor” thumbnail node, and is not self-referential.

While the tree structured browsing history display of FIGS. 10-11 have been illustrated with an unscaled second axis 53, it can be appreciated that a browsing history display with a timescaled second axis, such as illustrated in FIG. 8, can also be implemented for a tree structured browsing history display.

In some examples, a browsing history display may include a control, such as a radio button, that allows the user to select either the tree structure display mode (e.g. FIG. 10), or the linear display mode (e.g. FIG. 4) for displaying the browsing history. Similarly, a control may be included to allow the user to specify whether all, some, or none of the dashed lines 116 are to be displayed. An additional control may also be included to allow the user to specify whether the second axis 53 is unscaled or timescaled.

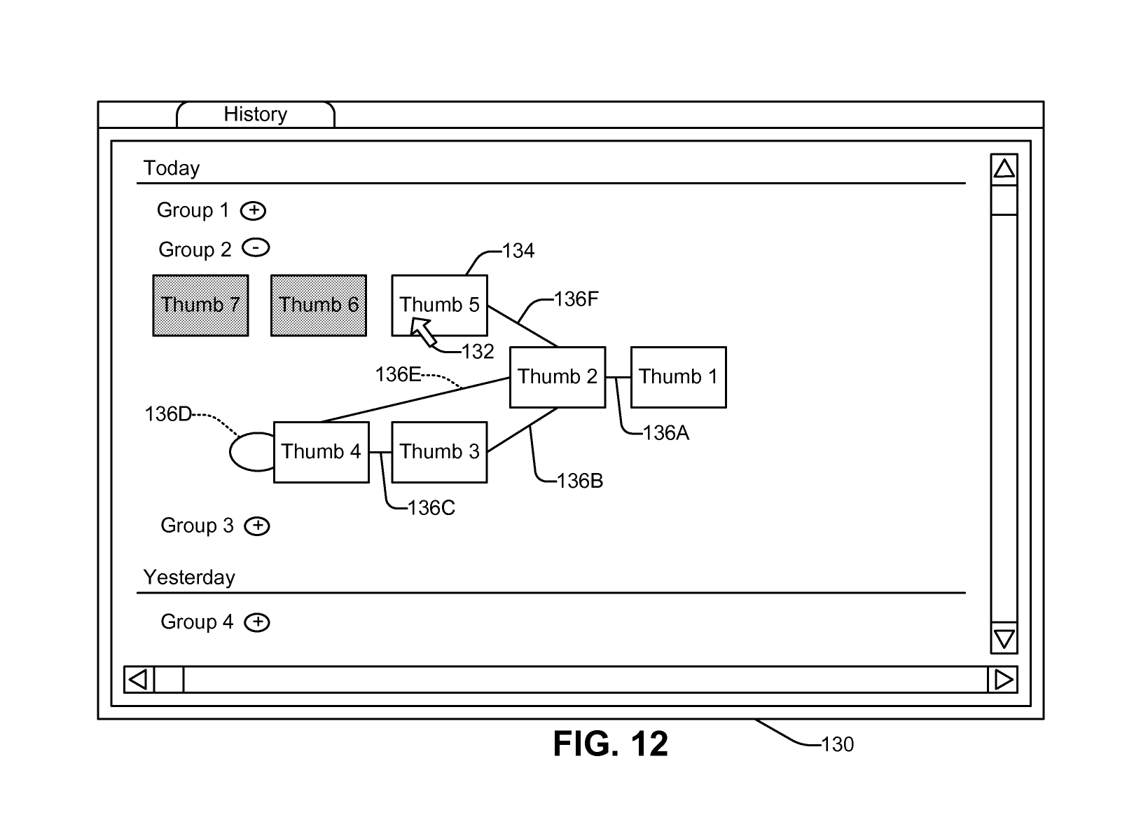

The browsing path to a particular web page can be presented for a tree structured browsing history display as in FIGS. 10-11, in an analogous manner to that illustrated in FIG. 6 for a linear browsing history display. In one example, and with reference to FIG. 12, a browsing path segment may be displayed for each web page browsing step that led to a selected web page. For example, to cause the browsing history display 130 to display the browsing path 136 used to arrive at the web page corresponding to thumbnail image Thumb 5 134, the cursor 132 may be hovered over the thumbnail image Thumb 5 134. Doing so causes the path segments 136A-F to be displayed. The path 136 shows that, while the web page corresponding to Thumb 5 134 was browsed to from Thumb 2, there were previous browsing steps from Thumb 2 to Thumb 3, to Thumb 4, and then back to Thumb 2. It is useful to display all the segments of browsing path 136 in instances where these earlier browsing steps affect what is displayed when the web page corresponding to Thumb 5 134 is browsed to.

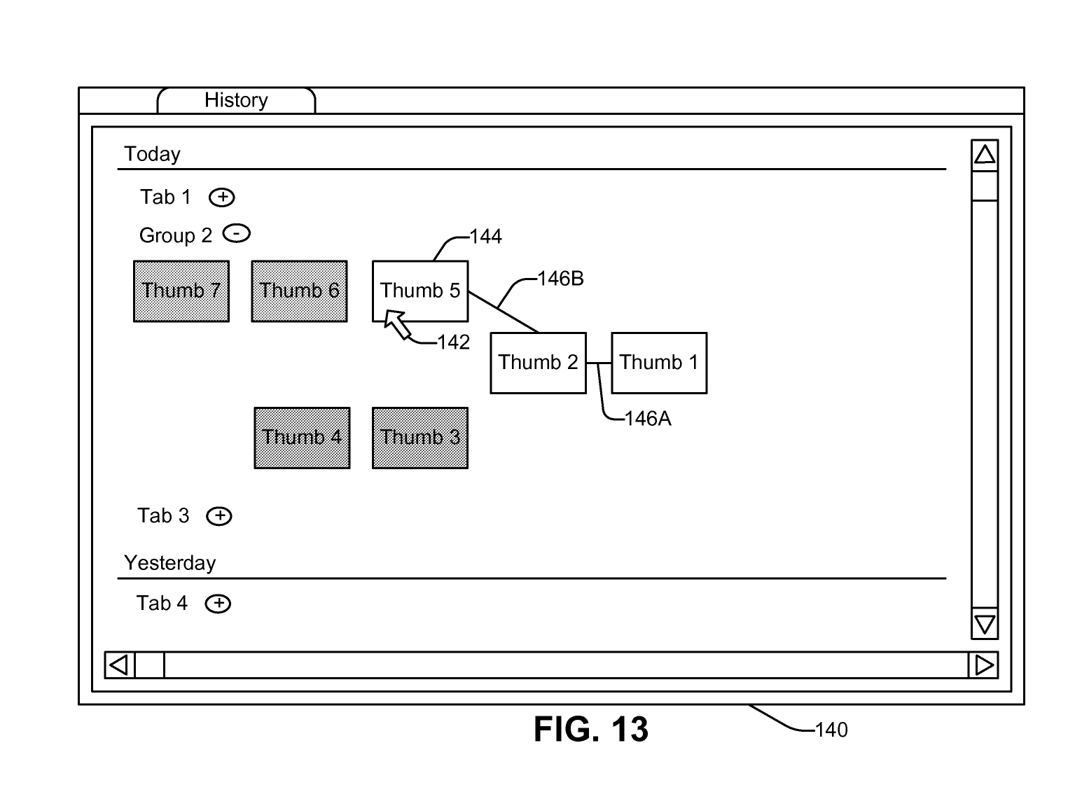

In another example, and with reference to FIG. 13, a browsing path includes path segments for web pages that are ancestors in the tree structure of the selected web page. For example, to cause the browsing history display 130 to display the browsing path 146 used to arrive at the web page corresponding to thumbnail image Thumb 5 144, the cursor 142 may be hovered over the thumbnail image Thumb 5 144. Doing so causes the path segments 146A-B to be displayed. Although the web pages corresponding to Thumb 3 and Thumb 4 were previously browsed to prior to browsing to Thumb 5 144, neither Thumb 3 nor Thumb 4 is an ancestor of thumbnail image Thumb 5 144. Thumb 3 is a sibling of Thumb 5 144, and as such Thumb 3 represents a different branch from Thumb 2 than does Thumb 5. It may be useful to display just the tree ancestors of a selected web page in instances where the earlier browsing steps do not affect what is displayed when the web page corresponding to Thumb 5 144 is browsed to, as a less cluttered browsing history display 140 results.

Consider now, with reference to FIG. 13, a flowchart of a controller 20 (FIG. 1) of an apparatus 10 that includes a web browser 22. Alternatively, the flowchart of FIG. 13 may be considered as steps in a method implemented in the controller 20. The method 200 begins at 210 by recording history information (history data) for each web page browsed by the browser. The history information includes a thumbnail image of the page and a group associated with the page. At 220, responsive to a user request, a two-dimensional browsing history is displayed. The displayed browsing history has one or more groups arranged along a first axis. Each group is expandable along a second axis, orthogonal to the first axis, to display, adjacent to the group, a thumbnail image of each browsed web page associated with that group.

In some examples, additional history information may also be recorded at 215. This additional history information may include, for a given web page browsed to by the web browser, one or more of: a URI of the web page; a date and time at which the web page was browsed to; a preceding web page browsed to by the web browser directly prior to the given web page; or a subsequent web page browsed to by the web browser directly after the given web page. The term “directly” is used here to specify that the web browser does not browse to any intermediate web pages between the given web page and the preceding or subsequent web page.

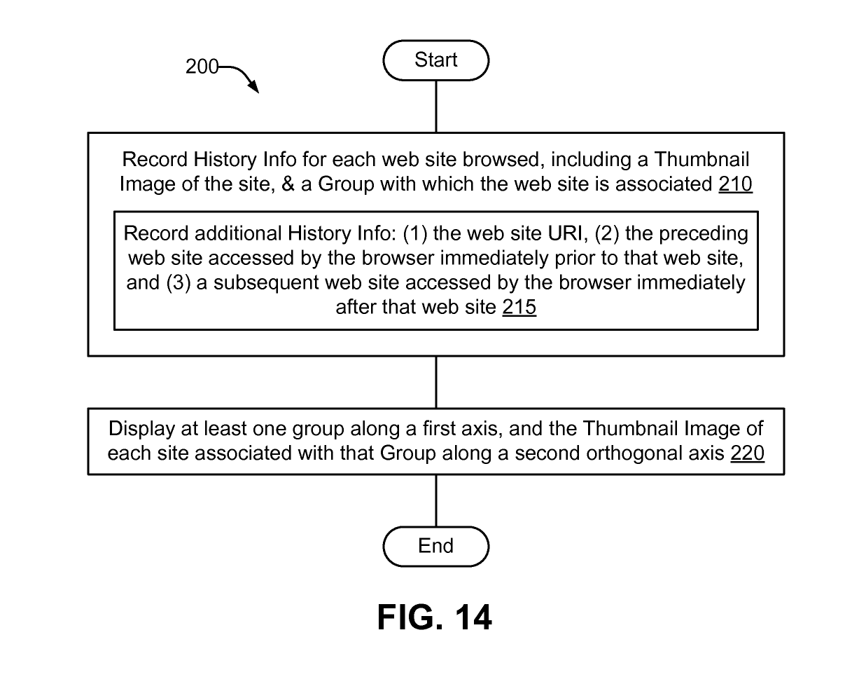

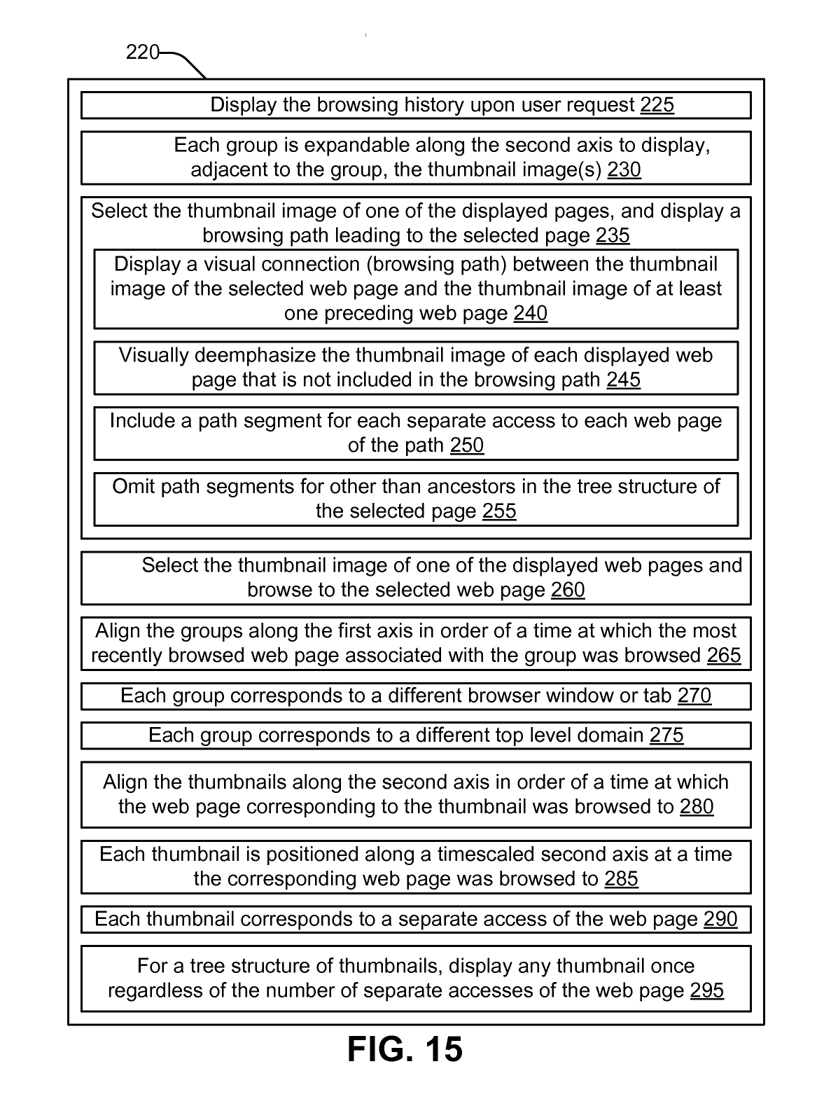

Considering now in greater detail the displaying 220 of the browsing history, and with reference to the lower-level flowchart of FIG. 14, in some examples one or more of the following operations may be performed.

At 225, the browsing history is displayed upon user request.

At 230, each group is expandable along the second axis to display, adjacent to the group, the thumbnail image(s).

At 235, the thumbnail image of one of the displayed web pages is selected, and in response to the selection a browsing path leading to the selected web site is displayed. The selection may be hovering a cursor over the thumbnail image. At 240, a visual connection (browsing path) between the thumbnail image of the selected web page and the thumbnail image of at least one preceding web page is displayed. A preceding web page is a web page associated with the group that was browsed to at some point in the browsing sequence before the selected web page was browsed to. At 245, the thumbnail image of each web page displayed in the browsing history display that is not included in the browsing path is visually deemphasized. At 250, a path segment is included for each separate access to each web page of the browsing path. At 255, path segments for other than ancestors in the tree structure of the selected web page are omitted. In other words, the path omits segments for other branches of the tree structure which correspond to web pages that were accessed by the web browser but do not lead to the selected web page in the tree.

At 260, the thumbnail image of one of the web pages displayed in the browsing history display is selected, and the web browser browses to the web page corresponding to that thumbnail image. The selection may be a double-clicking of the thumbnail image.

At 265, the groups are aligned along the first axis in order of a time at which the most recently browsed web page associated with the group was browsed.

At 270, each group is defined so as to correspond to a different tab or window of the web browser.

At 275, each group is defined so as to correspond to a different URI top level domain.

At 280, the thumbnail images are aligned along the second axis in order of a time at which the web page corresponding to the thumbnail image was browsed to.

At 285, the second axis is timescaled, and each thumbnail image is positioned along the second axis at a time the corresponding web page was browsed to.

At 290, each thumbnail corresponds to a separate access of the web page.

At 295, for a tree structure of thumbnails in the browsing history display, each thumbnail is displayed once regardless of the number of separate accesses of (i.e. browsings to) the web page.

From the foregoing it will be appreciated that the apparatus, method, and medium provided by the present disclosure represent a significant advance in the art. They provide the user a top-down view of his or her browsing history. The relationship between web pages and sites as the user moves through the web is presented to the user in a visual manner that assists navigation. These relationships, such as the browsing path taken to a particular web page, advantageously enable the user to more quickly and easily browse back to particular web content which he or she had previously accessed. The user might not remember the particular URL of a previously browsed-to web page, or even its top-level domain, but may have a visual image of the web page in mind, or recall a predecessor web page which brought them there.

Although several specific examples have been described and illustrated, the disclosure is not limited to the specific methods, forms, or arrangements of parts so described and illustrated. This description should be understood to include all novel and non-obvious combinations of elements described herein, and claims may be presented in this or a later application to any novel and non-obvious combination of these elements. The foregoing examples are illustrative, and no single feature or element is essential to all possible combinations that may be claimed in this or a later application. Unless otherwise specified, steps of a method claim need not be performed in the order specified. Similarly, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the disclosed examples. Further, methods or steps discussed within different figures can be added to or exchanged with methods or steps in other figures. Further yet, specific numerical data values (such as specific quantities, numbers, categories, etc.) or other specific information should be interpreted as illustrative for discussing the examples. Such specific information is not provided to limit examples. The disclosure is not limited to the above-described implementations, but instead is defined by the appended claims in light of their full scope of equivalents. Where the claims recite “a” or “a first” element of the equivalent thereof, such claims should be understood to include incorporation of one or more such elements, neither requiring nor excluding two or more such elements.

What is claimed is:

1. A method for displaying a browsing history of a web browser of a computer, comprising:
recording, with the computer, history information for each web page browsed by the browser including a thumbnail image of the page and a group associated with the page; and
displaying with the computer, responsive to a user request, a two-dimensional browsing history having one or more groups along a first axis, each group expandable along a second orthogonal axis to display, adjacent to the group, a thumbnail image of each browsed web page associated with that group.

2. The method of claim 1, wherein a URI of at least one of the browsed web pages has a different top-level domain from another of the browsed web pages.

3. The method of claim 1, comprising:
selecting the thumbnail image of one of the displayed web pages; and
displaying a browsing path leading to the selected web page in response to the selecting.

4. The method of claim 1, wherein the groups are aligned along the first axis in order of a time at the most recently browsed web page associated with the group was browsed to by the web browser.

5. The method of claim 1, wherein the thumbnail images are aligned along the second axis in order of a time at which the web page corresponding to the thumbnail image was browsed by the web browser.

6. The method of claim 1, wherein:
the second axis represents time, and
each thumbnail image is positioned along the second axis at a time at which the web page corresponding to the thumbnail image was browsed by the web browser.

7. The method of claim 1, wherein the thumbnail images are arranged linearly along the second axis, each thumbnail image corresponding to a separate access of the associated web page by the browser.

8. The method of claim 1, wherein the thumbnail images are arranged in a tree structure along the second axis such that the thumbnail image of any web page associated with the group is displayed once regardless of the number of separate accesses of the web page by the browser.

9. The method of claim 8, comprising:
displaying a browsing path to a selected web page, the path including a segment for each separate access to each web page of the path.

10. The method of claim 8, comprising:
displaying a browsing path to a selected web page, the path omitting segments for other than ancestors in the tree structure of the selected web page.

11. A web browsing apparatus, comprising:
a controller having a web browser including
a history recorder structured to save in a data store, for each of a sequence of web pages browsed by the browser, history data including a thumbnail image of the page and a group with which the page is associated; and
a history manager structured to, responsive to an input, display at least one group along a first axis and the thumbnail image of each page associated with that group along a second orthogonal axis.

12. The apparatus of claim 11, wherein a displayed thumbnail image corresponds to a web page that has a URI with a different top-level domain from the URI of another web page for which another thumbnail image is displayed.

13. The apparatus of claim 11,
wherein the controller is further structured to receive a selection of the thumbnail image of one of the displayed web pages, and
wherein the history manager is further structured to, in response to the selection, display a browsing path leading to the selected web page, the path comprising the sequence of web pages traversed by the browser to arrive at the selected web page.

14. The method of claim 13, wherein the displayed browsing path further comprises:
a visual connection between the thumbnail image of each of the web pages in the browsing path.

15. The method of claim 13, wherein the history manager is further structured to, in response to the selection, visually deemphasize the thumbnail image of each displayed web page that is not included in the browsing path.

16. A non-transitory computer-readable storage medium having an executable program stored thereon, wherein the program instructs a processor to:
record, as a web page is accessed by a web browser, history data including a thumbnail image of the page and a group with which the page is associated; and
process the history data upon request so as to display at least one group along a first axis and the thumbnail image of each page associated with that group along a second orthogonal axis.

17. The medium of claim 16, wherein the history data for a given web page further comprises:
a URI of the web page;
a date and time at which the web page was browsed to;
a preceding web page browsed to by the web browser directly prior to the given web page; and
a subsequent web page browsed to by the web browser directly after the given web page.

18. The medium of claim 16, wherein the program further instructs the processor to:
receive a selection of the thumbnail image of one of the displayed web pages; and
in response to the selection, browse to the selected web page.

19. The medium of claim 16, wherein each group corresponds to a different window of the web browser or a different tab of the web browser.

20. The medium of claim 16, wherein each group corresponds to a different top-level domain.
